(19) United States
(12) Patent Application Publication
(10) Pub. No.: US 2011/0102889 A1
(43) Pub. Date: May 5, 2011

(54) Displays

(76) Inventor: Vinesh Raja, Warwickshire (GB)

(21) Appl. No.: 11/920,281

(22) PCT Filed: May 12, 2006
(86) PCT No.: PCT/GB2006/001763

§ 371 Date: Dec. 10, 2008

(30) Foreign Application Priority Data
May 12, 2005 (GB) 0509682.1

(51) Int. Cl. G03B 21/56; G03B 21/62

(52) U.S. Cl. 359/451

(57) ABSTRACT

A display screen system comprising a screen, a projector for projecting images onto the screen and a driving mechanism, the system having a flat configuration and a curved configuration, the driving mechanism arranged to move the screen from bring substantially flat when the system is in the flat configuration to being curved along at least one dimension when the system is in the curved configuration.

This invention relates to the display system, in particular for projecting an image onto a screen for use as a virtual reality display system or home cinema system.

It is known to provide moving images such as for television, for films or computer simulation onto a screen by use of a projector behind a translucent screen or in front of an opaque screen. The projector typically takes digital images from a computer and projects them onto the screen. With these known systems the screen is almost always flat and consequently the viewer has a two dimensional experience unless special stereographic techniques are used which may require the use of specially made glasses to view the images correctly.

With virtual reality systems it is also known to make use of a projector with a specially adapted screen in order to make the experience more three dimensional. These are designed to encompass the user within an experience rather than be presented as a scene to be viewed from afar. Such systems generally do not use a single flat screen. There are four known systems used: the curved screen system, the cave system, the room system and the sphere system.

With the curved screen system, a screen is used which is curved in the horizontal direction but remains straight in the vertical direction. By having a sufficiently large curved screen and by using front projection, images can be projected onto this curved screen. Known software exists which can calculate how the image should be projected from the projector to be viewed correctly on the curved screen once the necessary input parameters of the distance from the screen and how the screen is curved etc. are entered. Alternatively, set images can be projected at a fixed distance from the screen and the output from the computer into the projector can be manually adjusted until the image fits correctly onto the screen. This curved screen system is advantageous in that the user is able to walk close to the curved screen, or even walk past the edges of the screen towards its set back mid point, and feel more encompassed by the screen. This is particularly advantageous in virtual reality systems where simulations can be run where the user wishes to feel that he/she is interacting with the projected images. However this system is not suitable for all applications.

The cave system consists of three flat surfaces which are used as screens which fit together to form a C shape. The angle between the middle surface and the two outer surfaces can be anything from 90 degrees to 175 degrees. This system can be used in a similar manner to the curved screen system but might use more than one projector for instance such as using one projector for each surface with a central computer co-ordinating the image being sent from each of the three projectors. Again this system is not suitable for all applications.

The room system is similar to the cave system and makes use of four or more, and possibly all six faces of a room. By providing a room with a completely plain floor, ceiling and walls it is possible to project images to surround the user in all directions. This system is particularly good at making the user feel within a simulation but it is difficult to provide by front projection without the user blocking the path of at least one projector and used with rear projection is costly since the projectors must be placed at a significant distance behind each of the floor, ceiling and walls of the room, with the walls being specially constructed of transparent material

The sphere system uses part or a whole sphere and the projector projects images onto this spherical surface. This system is good for providing the user with a 3D like experience, but again is not suitable for all applications and is best used with images that have been specially designed or adapted for use with such a screen.

It is an object of the present invention to provide improvements in the known systems and to provide a system that is suitable for use in a number of different applications.

According to the first aspect of the invention there is provided, a display screen system comprising a screen, a projector for projecting images onto the screen and a driving mechanism, the system having a flat configuration and a curved configuration, the driving mechanism arranged to move the screen from being substantially flat when the system is in the flat configuration to being curved along at least one dimension when the system is in the curved configuration.

Preferably the projector is for projecting digital images. Preferably the screen comprises a rigid maternal and more preferably the system comprises screen holders attached to two ends of the screen and connected to the drive mechanism. Preferably still the screen holders are closer together in curved configuration than in the flat configuration and/or the driving mechanism moves at least one of the holders closer to the other holder when changing from the flat to the curved configuration thereby compressing the attached screen and forcing it into being curved. Preferably the system comprises a guide which co-operates with the end holders, allowing them to move along it and more preferably the guide is arranged so that the holders maintain their relative angular orientation to each other through movement between the flat and the curved configurations and preferably so that the holders remain parallel.

The screen may curved in two dimensions in the curved configuration and preferably is shaped substantially like a spherical cap or segment. The screen in the curved configuration may be curved so that its surface has an extremum/maximum/minimum/stationary point and preferably a single global extremum/maximum/minimum/stationary point, that is that the surface curves away from each of the edges of the screen in directions normal to those edges.

Preferably the screen comprises a flexible material such as an elastic material.

Preferably the system comprises moveable holders which holders comprise attaching means for attaching/clamping to the screen. More preferably the moveable holders have an unclamped configuration in which they can move independently of the screen and a clamped configuration in which they move fast with the screen. More preferably there is a second driving mechanism which can move the moveable holders.

Preferably the system comprises a chamber located behind the side of the screen into which it is wished for the screen to curve into and a the driving mechanism comprises a pump connected to the chamber wherein the screen is moved from its position in the flat configuration to its by position in the curved configuration by using the pump to reduce the pressure in the chamber and thereby for external air pressure to force the screen to curve into the chamber and/or comprises a rigid backing adjacent the screen and a space between the screen, wherein the driving mechanism comprise a pump connected to the space and the screen is moved from its position in the flat configuration to its by position in the curved configuration by using the pump to increase the pressure in the space and thereby for the pumped in air to force the screen to curve outwardly away from the backing. More preferably the screen in the curved configuration curves from the places at which it is attached/clamped to the holders and/or a one way valve located between the pump and the camber/space.

The screen may be substantially transparent.

Preferably the system comprises a processor adapted to adjust the images projected by the projector. More preferably the processor is in communication with the driving mechanism and monitors movement of the mechanism and calculates consequent reshaping of the screen, wherein the processor using these calculations to automatically adjust or manipulate the image to be projected and/or settings of the projector when the system moves between the flat and curved configurations.

Preferably there are a plurality of display screen systems and more preferably two or more screens are hinged together so that the angles between the respective screens can be adjusted.

According to a second aspect of the invention there is provided a display screen system comprising a screen, a projector for projecting images onto the screen and a driving mechanism, the system having a first configuration and a second configuration, the driving mechanism arranged to move the screen from being substantially flat along at least one dimension when the system is in the first configuration to being curved along that one dimension when the system is in the second configuration.

According to a third aspect of the invention there is provided a display screen system, comprising a screen, a projector for projecting images onto the screen and a driving mechanism, the system having a cylindrical configuration and a curved/spherical configuration, the driving mechanism arranged to move the screen from being curved along one dimension when the system is in the cylindrical configuration to being curved along two dimensions when the system is in the curved/spherical configuration.

Embodiments of the invention will now be described, by way of example only, with reference to the accompanying schematic drawings in which;

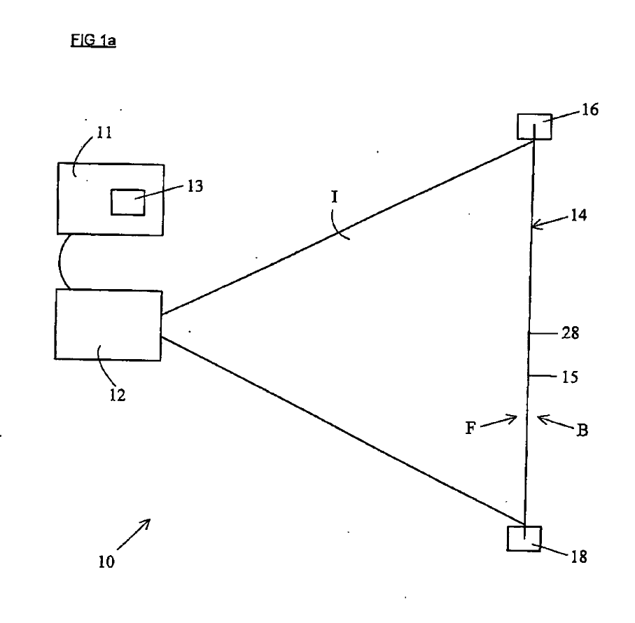

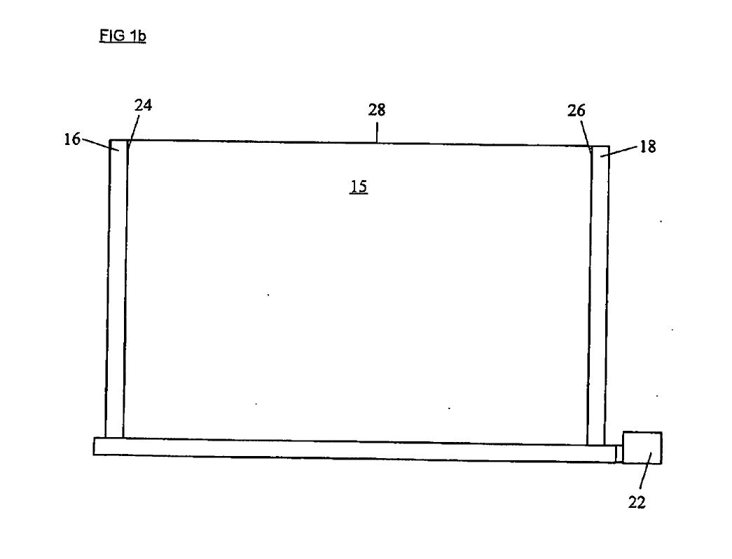

FIG. 1A is a top down view of a first embodiment of display system in accordance with the invention,

FIG. 1B is a front view of the system of FIG. 1A,

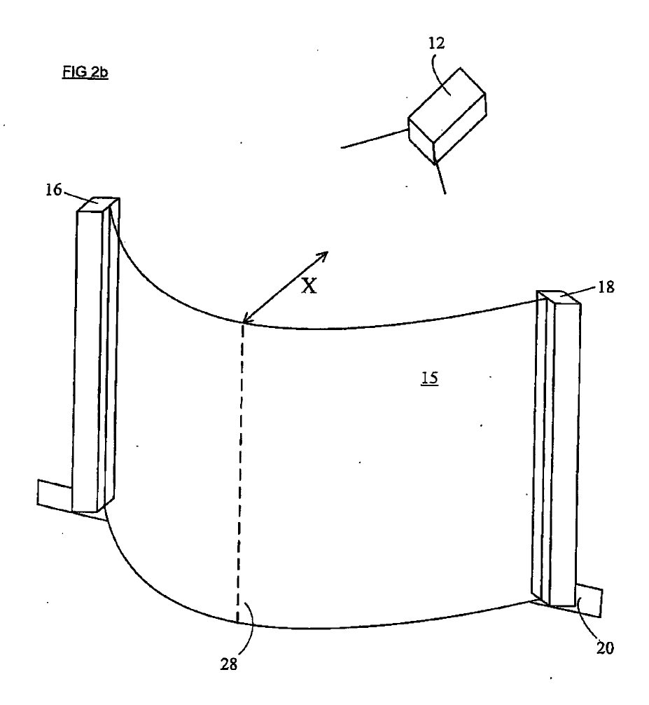

FIG. 2A is a top down view of the system of FIG. 1A in a second configuration,

FIG. 2B is a perspective view of the configuration shown in FIG. 2A,

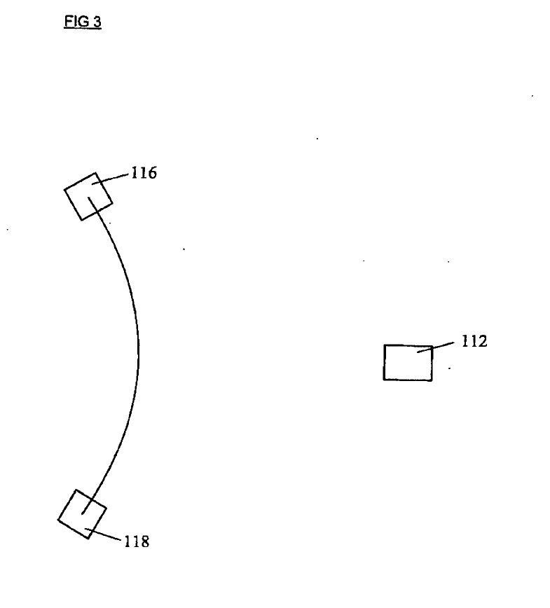

FIG. 3 is a top down view of a second embodiment of projection system according to the invention,

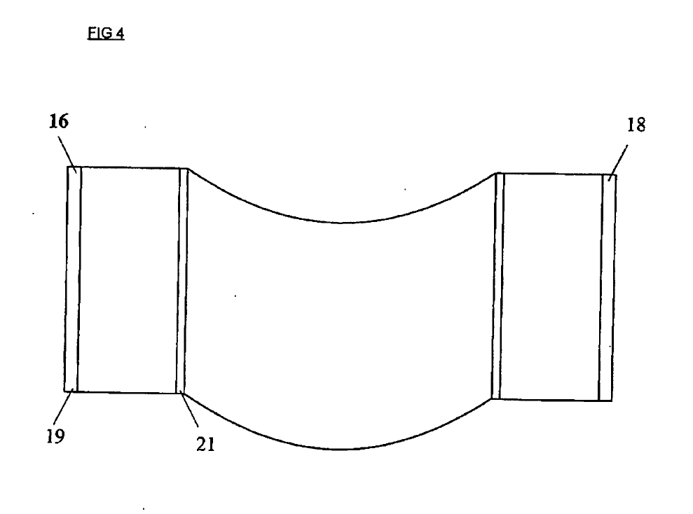

FIG. 4 is a perspective view of the system of FIG. 1A or FIG. 3 in a special configuration,

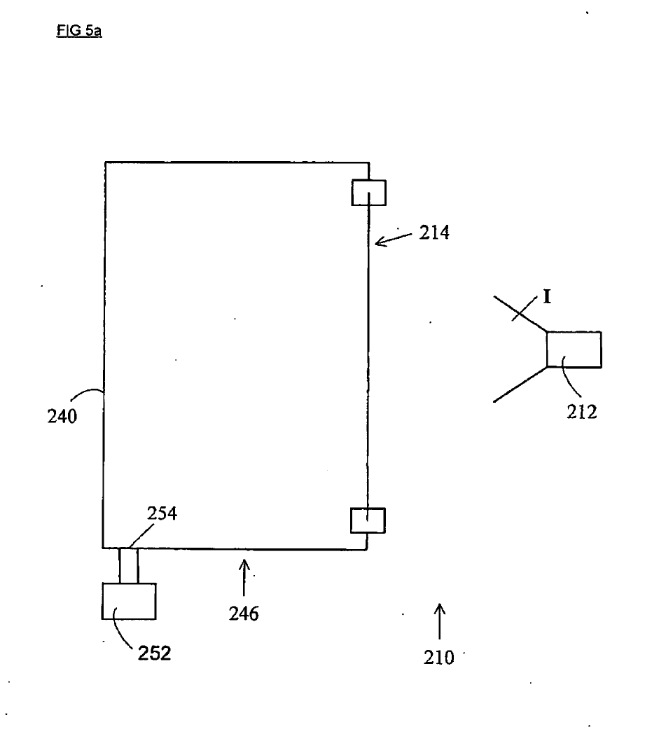

FIG. 5A is a top down view of a third embodiment of display system in accordance with the invention in the first configuration,

FIG. 5 B is a front view of the embodiment of FIG. 5A,

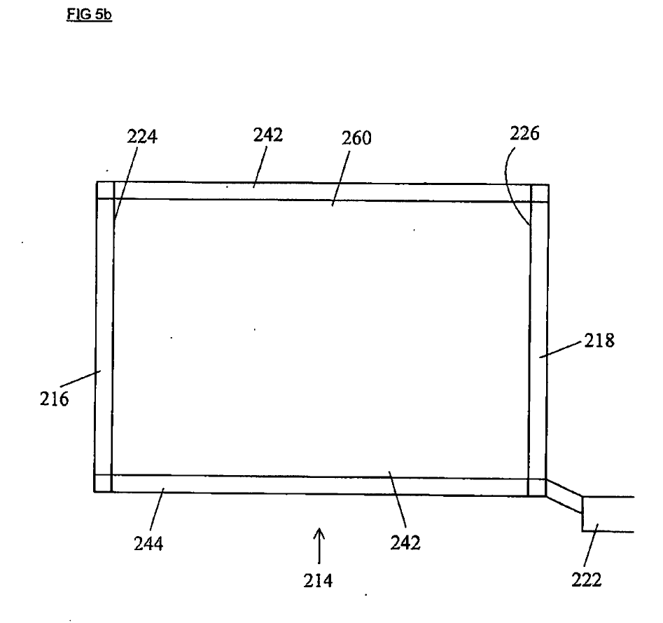

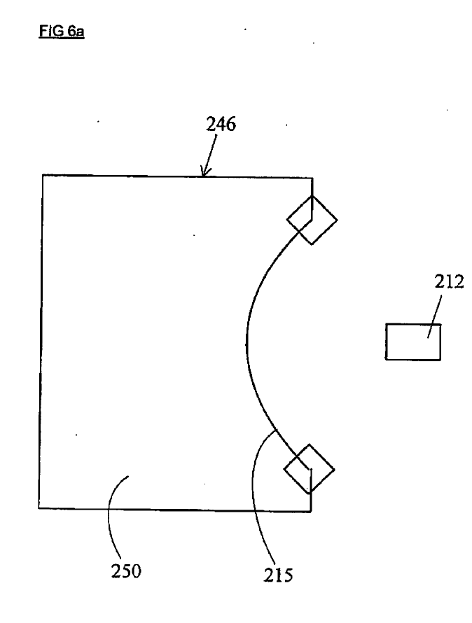

FIG. 6A is a top down view of the system of FIG. 5A in a second configuration,

FIG. 6B is a perspective view of the configuration of FIG. 6A,

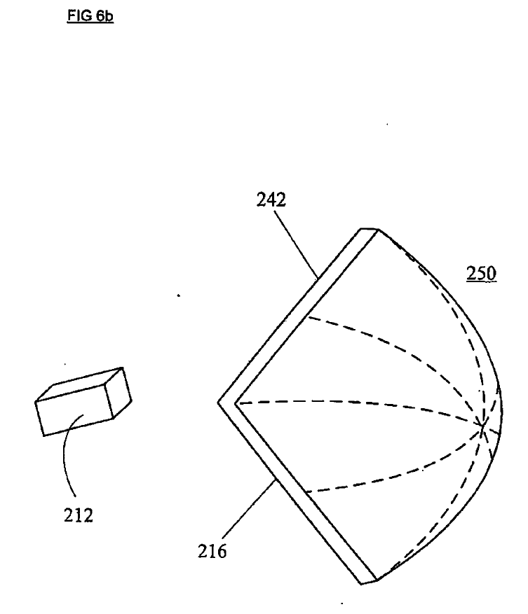

FIG. 7 is a perspective view of third configuration of a display system in accordance with the invention,

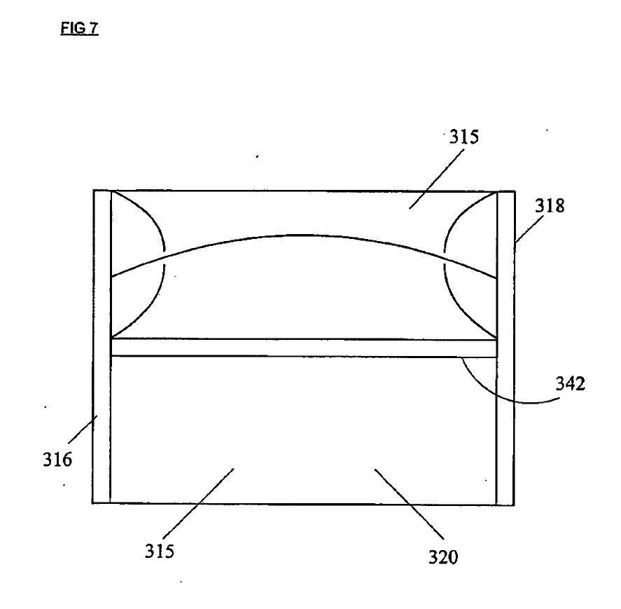

FIG. 8 is a top down view of a fourth embodiment of the system in accordance with the invention,

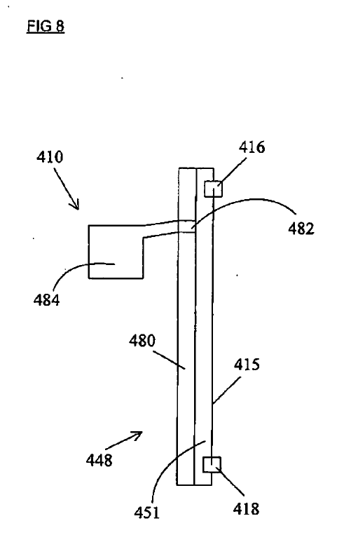

FIG. 9A is a top down view of the system of FIG. 8 in a second configuration,

FIG. 9B is a top down view of the system of FIGS. 8a and 9a in a different configuration,

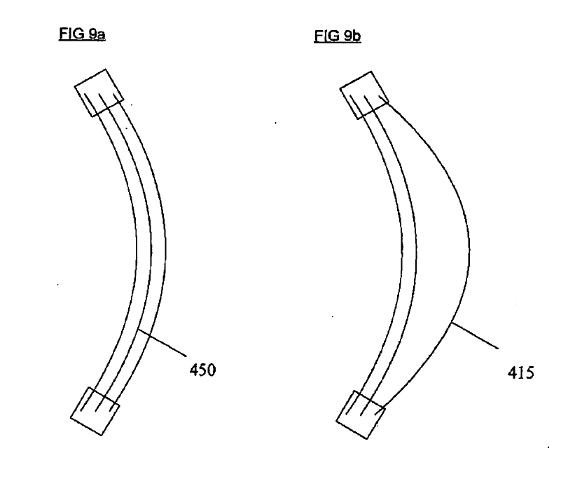

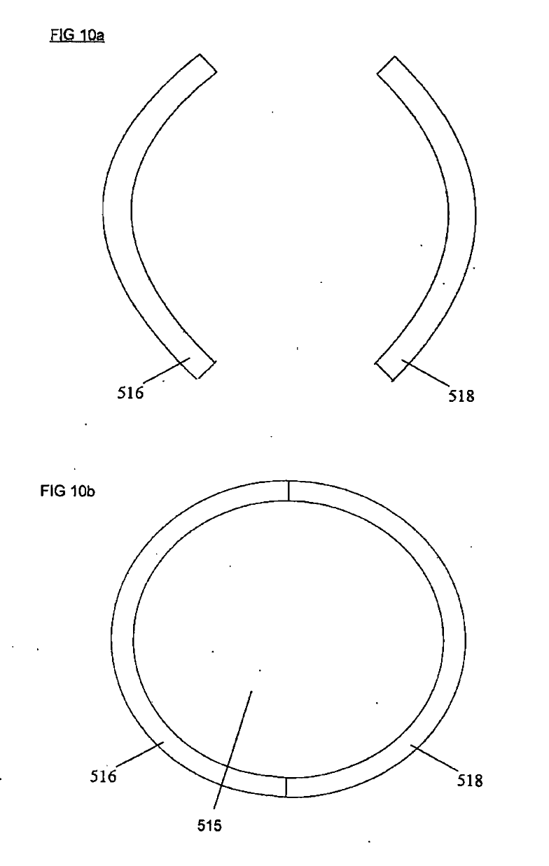

FIGS. 10A and 10B are views of alternative screen holders for use with the system shown in FIG. 4, FIG. 8 or FIG. 9.

Referring to FIGS. 1A and 1B there is shown a display system 10 in a flat screen configuration. The system 10 comprises a projector 12 and a screen 14. In this embodiment projector 12 is located on the opposite side of the screen 14 as the user U is intended to sit when using system 10.

Projector 12 is a conventional projector for projecting television, movies, computer simulations and the like. Projector 12 is also in communication with a computer 11 with a processor 13. Projector 12 is intended to project towards the screen 14 and in FIG. 1A a projected cone of digital Images I is illustrated schematically.

Computer 11 outputs digital images I to the projector 12 for projection onto the screen 14. The processor 13 can modify the images I before they are sent to the projector 12 in particular to affect distortion.

Screen 14 comprises a rigid sheet of opaque material 15, end clamps 16 and 18, a guide 20, and a driving mechanism 22. The sheet 15 is rectangular in shape as best seen in FIG. 1B.

In the horizontal direction sheet 15 has ends 24 and 26 and a mid point 28. Each of the ends 24, 26 is held in place and supported by an end clamp 16, 18.

In the embodiment shown, the end clamps 16, 18 are each slidingly attached to the guide 20 to provide a support for sheet 15.

The driving mechanism 22 comprises a motor mechanically connected to each of the end clamps 16 and 18.

In the flat configuration shown in FIGS. 1A and 1B the sheet 15 is substantively flat. Sheet 15 is transparent so that the projector 12 can project a two dimensional image onto its back surface B, which a user U can view in a similar way to the conventional flat screen projection systems. In an alternative embodiment sheet 15 can be opaque in which case the projector 12 can be located in front of the front surface F of the screen so that a user U located on the same side looking at the front surface F can see the front projected image.

The computer 11 runs software using processor 13, which enables a user to project an image to fit perfectly to fit onto the exposed front surface F of sheet 15. The software can automatically adjust the projected image to suit any configuration of the screen. This can be done by the screen 14 communicating with the computer 11 to provide details of its configuration allowing the software to create the appropriate images. It can also be done by using the computer 11 to control and drive the screen adjustment mechanisms adjusting the images I as it adjusts the screen 14 to suit its new geometry.

The driving mechanism 22 can be used to move the screen 14 from the flat configuration shown in FIGS. 1A and 1B to a curved configuration shown in FIGS. 2A and 2B. To do this the driving mechanism moves the end clamps 16,18, towards one another by a certain distance along the guide 20. In the curved configuration shown in FIG. 2a the screen forms part of the surface of a circular cylinder and this can also be referred to as a cylindrical configuration.

Once in the curved configuration as depicted in FIG. 2A, drive mechanism 22 or the guide 20 can have a lock mechanism which holds the end clamps 16 and 18 in their new locations. In the configuration shown in FIGS. 2A and 2B, each of the end clamps 20-22 have moved inwards by the same distance, D from their position in the flat configuration, which are depicted in FIG. 2A by dotted lines.

As the end clamps 16 and 18 are attached to the ends 24, 26 by a clamp, ends, 25 and 24 of the sheet 15 are also brought closer together when the end clamps are moved. Moving the ends of 24 and 26 closer together compresses the sheet 15 due to the rigidity of the material it is constructed of. Sheet 15 then bends to form the curved surface, CS, shown in FIGS. 2A and 2B. In order that sheet 15 bends in the desired direction, the end clamps 16 and 18 may comprise flanges or abutments which traverse a small distance along the front surface F of sheet 15 preventing it from bending in a forward direction. Alternatively or additionally, the sheet 15 is preconditioned to bend in a certain direction, having the sheet bent in the same direction several times before it is installed into system 10.

In FIGS. 2A and 2B it can be seen that mid point 28 is still in line with projector 12 and has not moved in a horizontal direction relative to the plane of the flat screen of FIGS. 1A and 1B. The mid point has though been moved backwards away from the projector 12 by distance X. Consequently there is a new region between the ends 24 and 26 and mid point 28 the projection of which onto the ground and ceiling forming segments of a circle. This new region is now accessible by the user U wishing to view the projected image. If the screen 14 is large enough, the user U can walk within this segment and be surrounded by projected images.

It is also possible to move into a curved configuration by only moving one of the clamping elements 16 or 18. This can allow for simpler mechanics between the drive mechanism 22 and the guide 20, which means only one end clamp need be moveable. However, this would mean that the mid point 28 would no longer be in line with the projector 12. The projector could of course be moved into a new position.

In the curved configuration it is generally necessary for projector 12 to be readjusted in order to be set up for the image to be displayed on this surface. This adjustment is done by software running on computer 11 using processor 13. This can be achieved in a number of ways.

One way it can be achieved is by linking the computer 11 to the drive mechanism 22 with the computer thereby being informed of any changes in the position of the end clamps 16 and 18 and to the distance which they have moved. The computer 11 is then able to calculate the new shape of the screen 15 from pre-entered data it has on the size and shape of the screen 15 stored in a memory, its distance from the projector and the distance which the end clamps have moved. Knowing the new shape of the screen it can then adjust the images I sent to the projector 12 and any settings of the projector accordingly.

Another approach is to output an image of a grid from computer 11 to projector 12 and consequently project a grid onto the screen 14. The processor 13 then adjusts the digital image of the grid until the grid projected onto the shaped surface CS of screen 14 is no longer distorted. This can be done by a human user indicating when the grid looks correct or by having sensors on the projector 12 which can view the grid and software running processor 13 which can co-ordinate the images viewed by the sensor with the adjustments made. These adjustments are made until the correct pattern is projected onto the screen 15.

A third method is to project an image which would look like a common shape, such as a circle if projected onto a flat surface, such as the screen 14 in the flat configuration FIGS. 1A and 1B. Such a shape when projected onto the curved surface CS will appear distorted. In a similar way to the grid the adjustments can be made until the regular intended shape is formed on the curved surface, either by manual confirmation or by use of sensors and automatic configuration.

If FIG. 3 is shown a second embodiment of display system 110 where identical or similar features or features with similar or identical functions are given the same reference number as corresponding features in FIGS. 1 and 2 but preceded by a 1. In this embodiment projector 112 is located in front of an opaque screen 115. The system 110 otherwise works in substantially the same way as system 110 but the projector 112 is positioned to minimise the chances of the user U blocking the path of images being projected onto the screen from projector 112. System 110 has the advantage of being front projected so that in the curved configuration it does not suffer the difficulties of stopping the images falling off the curved edge of the screen 114. System 10, however, is particularly useful when it is desired for the user to be able to walk into the segment defined by the curved configuration.

In FIG. 4 there is shown a third configuration of screen with can be used with either system 10 or system 110. In this embodiment, each of the end clamps 16, 116, 18, 118 comprises two components, a fixed clamp 19 and a releasable clamp 21. These two components can be separated and moved independently along the guide 20 by the drive mechanism 22. The fixed clamp 19 is firmly secured to the end 24 (or 26 for the other end clamp) whilst the moveable clamp 21 can be clamped or unclamped onto any part of the sheet 15. In order to achieve the special configuration shown in FIG. 4, the releasable clamp 21 is first released from sheet 15 and then moved inwardly relative to the sheet 15. When in position it is then clamped back onto the sheet 15. Once clamped the distance between each of the components 19 and 21 of each end clamp 18 and 20 is maintained if moved by the driving mechanism 22.

As with generating the curved configuration, the two end clamps 18 and 20 in their two part form, are then brought closer together. This causes the mid section of sheet 15, located between the two moveable clamps 21, to curve whilst the two end sections clamped between the two components 19 and 21 of the end clamps of 18 and 20 remain flat. Using such a two part end clamp it is possible to produce a variety of configurations of flat and curved sections.

A third embodiment of display system 210 is shown in FIGS. 5A and 5B. Components that have substantially similar functions to components of systems 10 and 110 are given reference numbers the same as their corresponding components but preceded by the number 2.

Display system 210 comprises a screen unit 246, including screen 214 and a projector 212.

The screen unit 246 comprises a screen 214 held within a housing 248. The housing 248 is empty defining a chamber 250. Unit 246 further comprises a pump 252 connected to the chamber 250 via a one way valve 254.

The screen 214 is shown in a flat configuration in FIGS. 5A and 5B. In addition to having end clamps 216 and 218 at horizontal ends, 224 and 226 of the sheet 215 the screen 214 also has two further end clamps 242 and 244 at vertical ends 260 and 262. The drive mechanism 222 for this embodiment is optional. When there is a drive mechanism there is also guides for both pairs 216 and 240 and 242 of end clamps. The screen 214 is airtight to prevent ingress into chamber 250.

In the configuration depicted in FIGS. 5A and 5B not only is the screen 214 flat but sheet 215 is substantially square.

Sheet 214 is not constructed of rigid material but instead is a flexible elastic membrane. In this embodiment, the sheet 215 is transparent for use with rear projection, with the projector 212 adapted to withstand large air pressures and located in the chamber 250. In alternative embodiments the projector 212 need not be so adapted and can be located behind a transparent chamber 250 or the sheet 215 may be opaque for use with front projection.

To move from a flat configuration to a spherical configuration, pump 252 is used. Pump 252 can be used to draw air out of chamber 250 and valve 254 prevents re-entry of this air back into the chamber 250. With air removed from chamber 250, the decompression/partial vacuum causes sheet 215 to be drawn in towards the chamber 250, with its ends 224, 226, 250 and 252 held in place by its end clamps 216, 218, 242, 244.

After the desired amount of air is drawn out by pump 252, the system 210 will be in the near-spherical configuration illustrated in FIGS. 5A and 5B. In the configuration shown in FIGS. 5A and 5B unlike the curved configuration of system 10, the end clamps 216 and 218 have not moved any closer together and therefore in its curved spherical state the length of material between the end clamps 216 and 218 is greater than the flat configuration shown in FIGS. 4A and 4B. In this embodiment, this is achieved by the use of a suitable stretchable elastic material which stretches to accommodate this extra amount required. Alternatively, it could be achieved by using a section of sheet 215 which is substantially larger than the square being delimited by the end clamps 216, 218, 240 and 242 and by temporarily releasing the clamps from the material and guiding the material with wheels to allow extra material of the sheet 215 to be drawn through the end clamps into the chamber 250. Once sufficient material has been drawn in the end clamps 216, 218, 240 and 242 are then clamped back down onto the material, holding it firmly in place.

As best seen in FIG. 6B, which is shown from the chamber side of screen 14, the sheet 215 now curves not only in a horizontal direction but in all directions forming a pinnacle at mid point 228, with the sheet 250 curving from this pinnacle towards an end clamp in every direction.

Similar methods of adjusting the projector for use with the near-spherical configuration can be used as with the system 10 for the curved configuration to enable the images to be correctly focussed.

It is also possible for each of the end clamps to be in a two part form similar to those depicted in FIG. 4. Using the moveable parts, the shape of sheet 250 delimited by the end clamps can be changed from a square to any form or shape of rectangle. Consequently the spherical configuration produced by using pump 252 will result in a different shape such as that shown in FIG. 6 in screen 315. In order to prevent the section of material between components 319 and 331 of each end clamp, also being pulled backwards by the partial vacuum of the chamber 350, it is possible for sections of rigid material 370 to be fixed to each of ends clamps and for these to drawn across the front of housing 348 just behind the back surface of sheet 315 when the movable parts 321 are moved.

Referring to FIG. 7 there is shown a fifth embodiment of the display system 410 shown in the flat configuration. System 410 can be used to produce near spherical configurations in a similar manner to system 210. Rather than a chamber 250, as defined by a housing 248, system 410 uses a rigid layer of material 480 to which each of the four sides of the square material 415 are attached. The sheet of material 470 also comprises a valve with connected pump 484. Rather than draw air out of the chamber, pump 484 pumps air inwardly past the valve 482 into space 451 between the sheet of material 415 and the layer 470. Pumping air in this way, the configuration in 410 can move from the flat configuration as shown in FIG. 7 to a near spherical configuration as shown in FIG. 8. If a user wishes to use the screen in a concave form rather than convex, the layer of material 470 can be of a transparent material which allow images to projected through this layer onto the material 415. Using this system, the screen 414 can be either front or back projected.

The system 410 can also be adapted to include all of the features of systems 10 or 110 with the layer 470 being used like screen 15 or 115 and being compressible into a curved configuration by the driving mechanism 422, moving parts of end plates 421 closer together. Such a curved configuration is depicted in FIG. 9A. It is also possible to use this in conjunction with the near-spherical configuration of system 310 in the layer and then inflating the layer material for 415 away from the layer in the same manner as described above to produce the configuration shown in FIG. 9B.

Any systems which uses end clamps can also be used with flexible end clamps as shown in FIGS. 12A and 12B, with reference numbers 516 and 518. These end plates 80, 518 can be moved such as by driving mechanisms or by manual manipulation from being straight to being curved. These curved end plates 516 and 518 can then be moved across the surface of sheet 51, 515 etc. in a similar manner to moveable clamps 21 and the area of material which is delimited by the end clamps 516 and 518 can be moved between configurations in the same way as systems described above. These allow different shapes to be formed. For example, as shown in FIG. 12B, the area given can be a circle, such that if a she is drawn into a spherical like configuration by inflation or by vacuum, a perfect hemisphere will be formed.

What is claimed is:

1. A display screen system comprising a screen, a projector for projecting images onto the screen and a driving mechanism, the system having a flat configuration and a curved configuration, the driving mechanism arranged to move the screen from being substantially flat when the system is int h flat configuration to being curved along at least one dimension when th system is in the curved configuration.

2. The display screen system according to claim 1 wherein the projector is for projecting digital images.

3. The display screen system according to claim 1 where in the curved configuration the screen is curved in one dimension.

4. The display screen system according to claim 1 in which the screen comprises a rigid material.

5. The display screen system according to claim 3 which system comprises screen holders attached to two ends of the screen and connected to the drive mechanism.

6. The display screen system according to claim 5 wherein the screen holders are closer together in curved configuration than in the flat configuration.

7. The display screen system according to claim 5 wherein the driving mechanism moves at lest one of the holders closer to the other holder when changing from the flat to the curved configuration thereby compressing the attached screen and forcing it into being curved.

8. The display screen system according to claim 6 wherein the system comprise a guide which co-operates with and end holders, allowing them to move along it.

9. The display screen system according to claim 8 wherein the guide is arranged so that the holders maintain their relative angular orientation to each other through movement between the flat and the curved configurations and preferably so that the holders remain parallel.

10. The display screen system according to claim 1 wherein the screen is curved in two dimensions in the curved configuration and preferably is shaped substantially like a spherical cap or segment.

11. The display screen system according to claim 1 wherein the screen in the curved configuration is curved so that its surface has an extremum/maximum/minimum/stationary point and preferably a single global extremum/maximum/minimum/stationary point, that is that the surface curves away from each of the edges of the screen in directions normal to those edges.

12. The display screen system according to claim 10 in which the screen comprises a flexible material.

13. The display screen system according to claim 12 in which the screen comprises an elastic material.

14. The display screen system according to claim 10 in which the system comprises moveable holders which holders comprise attaching means for attaching/clamping to the screen.

15. The display screen system according to claim 14 wherein the moveable holders have an unclamped configuration in which they can move independently of the screen and a clamped configuration in which they move fast with the screen.

16. The display screen system according to claim 15 comprising a second driving mechanism which can move the moveable holders.

17. The display screen system according to claim 10 comprising a chamber located behind the side of the screen into which it is wished for the screen to curve into and the driving mechanism comprises a pump connected to the chamber wherein the screen is moved from its position in the flat configuration to its by position in the curved configuration by using the pump to reduce the pressure in the chamber and thereby for external air pressure to force the screen to curve into the chamber.

18. The display screen system according to claim 10 which comprises a rigid backing adjacent the screen and a space between the screen, wherein the driving mechanism comprise a pump connected to the space and the screen is moved from its position int he flat configuration to its by position in the curved configuration by using the pump to increase the pressure in the space and thereby for the pumped in air to force the screen to curve outwardly away from the backing.

19. The display screen system according to claim 17 and either claim 15 or claim 16 wherein the screen in the curved configuration curves from the places at which it is attached/clamped to the holders.

20. The display screen system of claim 19 comprising a one way valve located between the pump and the camber/space.

21. The display screen system of claim 1 wherein the projector is located in front of the screen with respect to the intended position of a person viewing the screen.

22. A display screen system of claim 1 wherein the projector is located at the rear of the screen with respect to the intended opposition of a person viewing the screen.

23. A display system according to claim 22 wherein the screen is substantially transparent.

24. A display system according to claim 1 which comprises a processor adapted to adjust the images projected by the projector.

25. The display screen system according to claim 24 wherein the processor is in communication with the driving mechanism and monitors movement of the mechanism and calculates consequent reshaping of the screen, wherein the processor using these calculations to automatically adjust or manipulate the image to the projected and/or settings of the projector when the system moves between the flat and curved configurations.

26. A display system comprising a plurality of display screen systems according to claim 1 or comprising a projector and a plurality of screens and driving mechanisms according to claim 1.

27. The display screen system according to claim 1 wherein two or more screens are hinged together so that the angles between the respect screens can be adjusted.

28. A virtual reality display screen system comprising the display system of claim 1 the projector being for displaying virtual reality images onto the screen the system comprising a computer for producing virtual reality systems.

29. A display screen system comprising a screen, a projector for projecting images onto the screen and a driving mechanism, the system having a first configuration and a second configuration, the driving mechanism arranged to move the screen from being substantially flat along at least one dimension when the system is in the first configuration to being curved along that one dimension when the system is in the second configuration.

30. The display screen system, according to claim 29 comprising a screen, a projector for projecting images onto the screen and a driving mechanism, the system having a cylindrical configuration and a curved/spherical configuration, the driving mechanism arranged to move the screen from being curved along one dimension when the system is in the cylindrical configuration to being curved along two dimensions when the system is in the curved/spherical configuration.
